(19) United States
(12) Patent Application Publication
(10) Pub. No.: US 2011/0233097 A1
(43) Pub. Date: Sep. 29, 2011

(54) PACKAGING ASSEMBLY INCLUDING A BLISTER CARD HAVING A VAPOR BARRIER

(75) Inventor: Kerri Clark, Morristown, NJ (US)

(73) Assignee: Kraft Foods Global Brands LLC, Northfield, IL (US)

(21) Appl. No.: 13/120,701

(22) PCT Filed: Sep. 25, 2009
(86) PCT No.: PCT/US09/58308

§ 371 Date: Jun. 6, 2011

Related U.S. Application Data
(60) Provisional application No. 61/103,026, filed on Oct. 6, 2008.

(51) Int. Cl. B65D 75/36; B31B 1/14

(52) U.S. Cl. 206/461; 493/56

(57) ABSTRACT

A package assembly (10) and method of forming a package assembly accommodates product. The package assembly includes a planar member having a first surface. A moisture barrier (20) is disposed on a selected portion of the first surface to define a footprint thereon. The product (16) is positioned adjacent the moisture barrier within the footprint so as to define a perimetrical moisture barrier edge portion therearound. A blister cover (14) includes a blister cavity for receipt of the container. The blister cover includes a planar perimetrical rim therearound. The blister cover is supported on the first surface of the planar member with the perimetrical rim overlying the moisture barrier edge.

### CROSS REFERENCE TO RELATED APPLICATIONS

This application claims priority to U.S. Provisional Patent Application No. 61/103,026 filed on Oct. 6, 2008, the contents of which is incorporated herein by reference in its entirety.

### FIELD OF INVENTION

The present invention relates generally to a blister package assembly for supporting a container of consumable products. More particularly, the present invention relates to a blister package assembly including a blister card having a vapor barrier thereon.

### BACKGROUND OF THE INVENTION

Blister package assemblies are well known for supporting product for display and sale. Typically, a clear blister, formed from a variety of plastic materials, is adhered to a paperboard card or backing panel to form an enclosure for containing the product. The card itself may be used as a hang card to display packaged product in a retail environment. The blister closes and protects the product while providing the consumer with the ability to view the product through the blister. The blister card, in addition to being used to hang the product for display, can also contain labeling, identifying and advertising indicia thereon.

Blister cards are typically formed of paperboard or other similar materials chosen mostly for purposes of economy. The blister itself may be heat sealed around the product supported on the blister card so as to capture the product between the blister and the card, Since the material forming the blister card is selected based primarily on economic advantage, the blister card itself may not provide certain protective qualities to the product supported thereon. For example, with respect to consumable products such as pharmaceuticals or confectionery products the paperboard blister card provides little or no moisture protection for the product, which in certain instances may be extremely moisture sensitive. Certain blister card assemblies have addressed the need for providing moisture protection to the products contained within the package.

One example is shown in U.S. Pat. No. 6,691,870 where a multi-layered blister card is provided where one layer includes a barrier layer which may be attached to one side of a single card layer or between two card layers. Similarly, U.S. Patent Publication No. 2003/0196925 shows a blister card having a moisture barrier coating applied to the entire surface of one side of the card. As may be appreciated, using a moisture barrier on the entire blister card greatly increases the expense of manufacture of such a package.

U.S. Pat. No. 5,803,248 shows a moisture resistant blister package where a two-piece fully enclosed blister is attached to a blister card. The product must be retained in the two-piece blister and then placed on the card. Providing such a two-piece blister which must then be attached to a blister card greatly increases the cost of manufacture of the package assembly.

It is, therefore, desirable to provide a blister package assembly which is moisture rests ant and which can be economically produced.

### SUMMARY OF THE INVENTION

The present invention provides a package assembly which includes a planar member having a first surface. A vapor barrier is disposed on a selected portion of the first surface and defines a product accommodating footprint thereon. A blister cover includes a blister cavity for receipt of the product and a planar perimetrical rim thereabout. The blister cover is supported on the first surface of the planar member with the perimetrical rim overlying a perimetrical edge of the vapor barrier.

In a method aspect of the present invention, a method of forming a package assembly includes forming a planar member. A vapor barrier is deposited on a selected portion of the planar member to define a footprint having a perimetrical edge. A blister cover is provided having a blister cavity with a planar rim thereabout. Product is positioned within the blister cavity and the planar member is attached to the blister cover such that the rim of the blister cover overlies the edge of the vapor barrier.

In a preferred embodiment, the vapor barrier is a moisture barrier.

### BRIEF DESCRIPTION OF THE DRAWINGS

FIG. 1 is a perspective showing of the package assembly of the present invention.

FIG. 2 is an exploded perspective showing of the components of the package assembly of FIG. 1.

FIG. 3 is an enlarged sectional showing of the package assembly of FIG. 1.

FIG. 4 is a schematic plan view of the blister package assembly of the present invention supporting different product configurations.

### DETAILED DESCRIPTION OF THE PREFERRED EMBODIMENTS

The present invention provides a packaging assembly including a blister card and blister which supports product and provides a moisture barrier on the blister card so that the blister card and the blister supports the product in a manner where it is protected from moisture. While one purpose of the present invention is to prevent moisture from entering into the package assembly, and the preferred embodiment will be described with respect thereto, the present invention also may contain product which may have volatile components. The package assembly of the present invention would prevent the escape of such volatile components. Thus, the present invention provides generally a vapor barrier on the blister card when it is used in association with the blister to enclose the container.

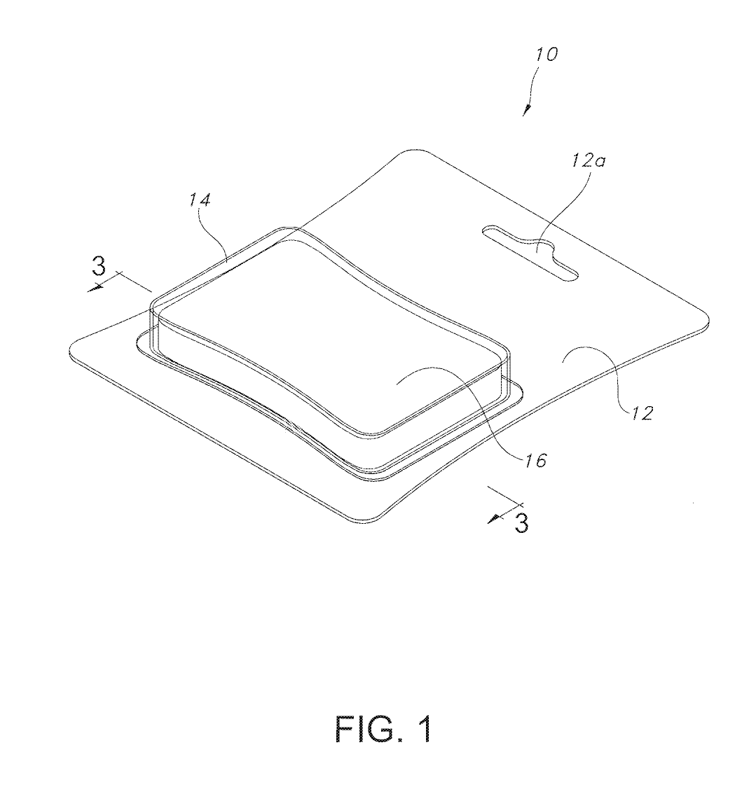

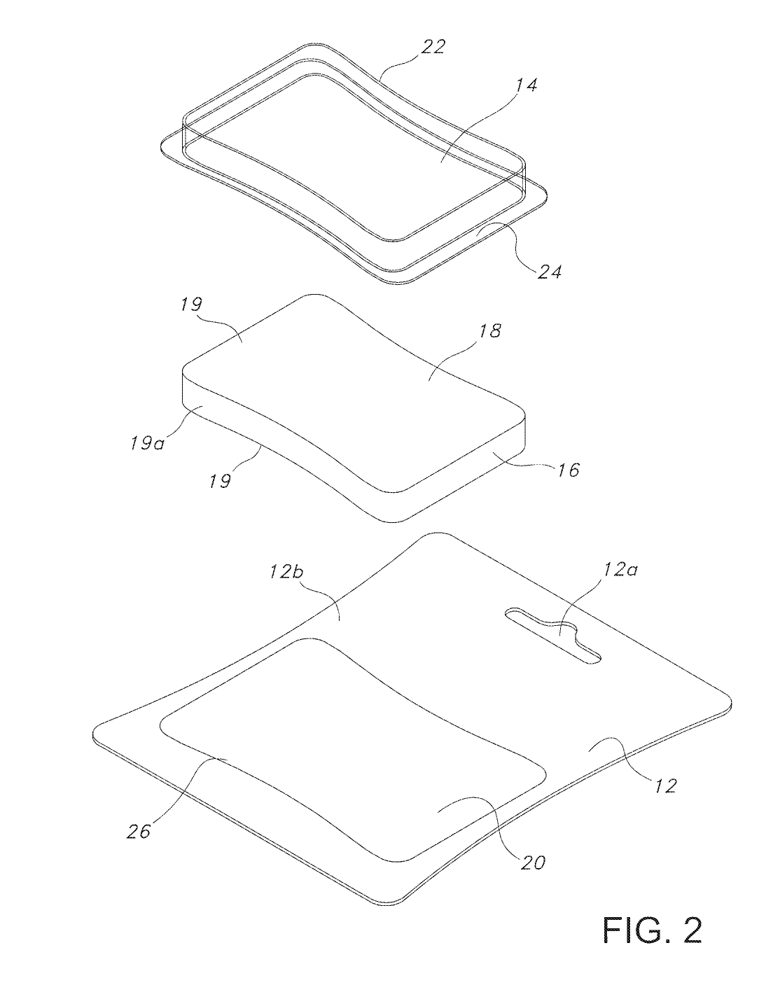

Referring now to FIGS. 1 and 2, the package assembly 10 includes a blister card 12 and a blister 14 which supports therebetween a container 16 containing products (not shown) preferably consumable pieces. The present invention is designed to enclose the container 16 in a manner which prevents moisture from adversely effecting the quality of the product contained within the package. While a container 16 is shown in FIGS. 1-4 as a preferred embodiment of the product, the present invention may support various product configurations and combinations therefore. For example, FIG. 4 shows the package assembly supporting a single container 16, plural containers 16a as well as plural loose pieces 16b. It is within the contemplation of the present invention that the package assembly 10 may support any or all of these or other types of items in any combination. For simplicity of explanation, the preferred embodiment will be described with regard to supporting container 16.

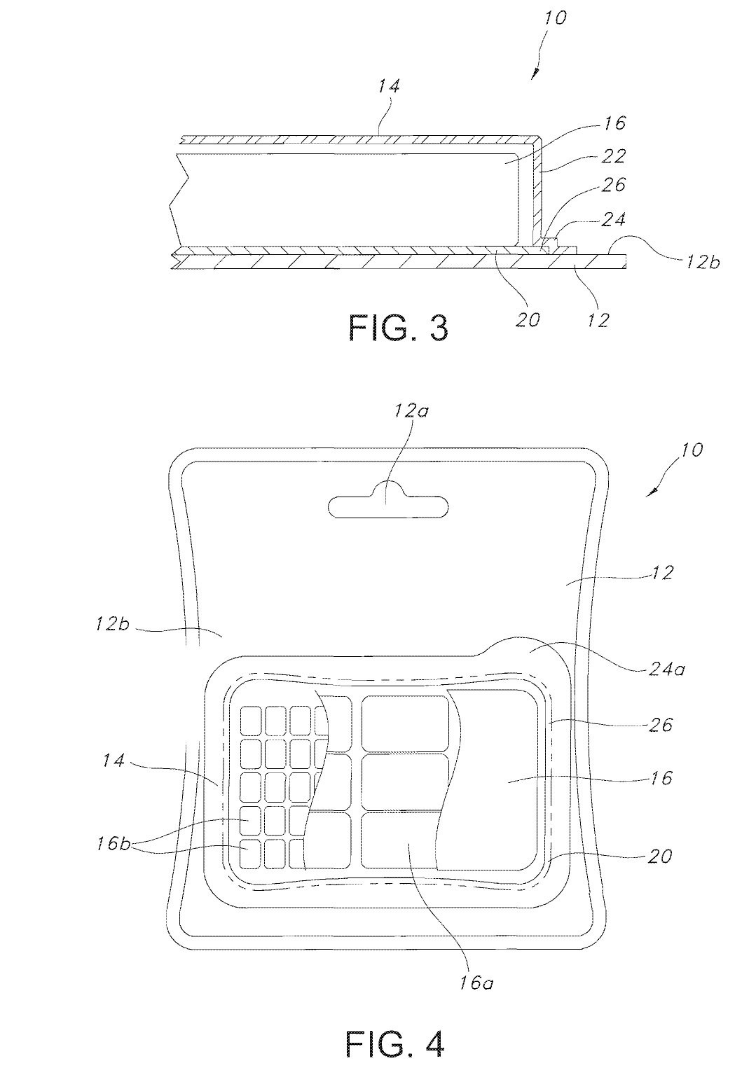

Referring additionally to FIGS. 3 and 4, the blister card 12 is a generally conventional planar member which is typically formed of one or more layers of cardboard, paperboard or the like. The blister card 12 may be formed from single or multiple plies of material and may be cut into any desirable shape. In the present illustrative embodiment, the blister card 12 is used to support container 16 in a manner which functions as a hang card. The upper end of blister card 12 includes a punched out aperture 12a which allows the blister card 12 to be hung from a peg for display purposes in a retail environment. The blister card may also be formed of material which allows printing of advertising, information or other indicia thereon.

While the materials which form the blister card 12 may be selected from any of a wide variety of known materials, the materials are typically selected due to cost and manufacturing efficiencies. Thus, the particular materials typically used for forming a blister card do not provide barrier protection for the products supported by the blister card.

The present invention, therefore, provides a moisture barrier 20, which is formed on a portion of a front surface 12b of blister card 12. The moisture barrier 20 defines a footprint on the surface 12b which, as will be described in further detail hereinbelow, generally approximates and extends beyond the configuration of the container 16 supported thereon. In the present illustrative embodiment, the moisture barrier 20 may be a metalized film or metal foil which is hot stamped onto surface 12b of card 12. While metalized film and foil are the preferred barriers, any material having high barrier protection properties may be employed.

The container 16 is a conventional package used to hold a plurality of consumable products. This container includes a housing 18 which may be formed in any desirable shape and of a wide variety of known materials. The housing 18 supports a plurality of consumable products (not shown) which may be individually dispensed from the container through an appropriately formed opening (not shown) therein. The container 16 may support a wide variety of consumable products such as, but not limited to candies, gums, pharmaceutical tablets and combinations thereof. The housing 18 may take any desirable shape, but preferably has a pair of opposed spaced apart planar surfaces 19 and a perimetrical side wall 19a therebetween. The configuration of the container 16 may also be selected for aesthetic purposes.

The moisture barrier 20 on blister card 12 is designed to have a general configuration which matches the planar surface 19 of housing 18. As more fully shown in FIG. 4, the moisture barrier 20 has a configuration which defines a footprint which extends slightly beyond the perimeter of the container 16 when the container is placed thereon. This defines a perimetrical edge portion 26 of the footprint. This edge portion is defined as the portion of the footprint which extends beyond the container 16 when placed thereon.

Blister 14 is a conventionally formed blister which is preferably selected to be transparent so as to permit viewing of the container 16 supported within package assembly 10. The blister 14 includes an upwardly extending blister portion 22 generally matching the configuration of container 16 and a perimetrical planar rim 24 extending thereabout. The blister is constructed such that the extending blister portion 22 is positioned within the footprint of moisture barrier 20 when placed on blister card 12. Thus, the perimetrical rim 24 of blister 14 overlies the perimetrical edge portion 26 of barrier 20 as shown in FIGS. 3 and 4.

As particularly shown in FIG. 3, the blister 14 is positioned over surface 12b of card 12 so as to overlie barrier 20. With the container 16 supported therebetween, the planar rim 24 of blister 14 is secured to the surface 12b of card 12 so as to overlie the edge portion 26 of barrier 20. The planar rim 24 is sealingly attached to the card 12 so that a seal is provided about the barrier 20. In that regard, it is contemplated that the planar rim 24 at least overlaps the perimetrical edge portion 26 of barrier 20. It is further contemplated that the barrier 20 may have a sufficient extent so that the barrier edge portion 26 extends outside the boundary of perimetrical rim 24 so that the rim 24 is fully sealed to the moisture barrier 20. In either situation, a sealed barrier is provided between the blister 14 and the harrier 20 which, in the preferred embodiment, prevents moisture ingress to the container 16 supported within the blister 14.

Having described the preferred configuration of the package assembly 10 of the present invention, one technique to form the package assembly 10 of the present invention may be described.

Typically, a sheet of stock material not shown is employed. This sheet of material will form multiple blister cards 12. Appropriate indicia may be printed on one surface of the stock material and a plurality of moisture barriers 20 will be hot stamped thereon. After printing and hot stamping the moisture barrier 20, the stock material is cut into individual blister cards 12.

An individual container 16 is loaded into the open end of a blister 14. Thereafter, an individual blister card 12 is positioned over the open end of each blister 14 so that the container 16 is registered within the footprint of the moisture barrier 20. The perimetrical rim 24 of the blister is preferably heat seated to the card an as to establish a seal between the perimetrical rim 24 and the edge portion 26 of the moisture barrier 20.

The package assembly 10 may be used by removing the blister 14 from the front surface 12b of blister card 12. In that regard, as shown in FIG. 4, a tab 24a is provided on one corner of planar rim 24 to help remove the blister 14 from card 12. The heat seal, while sufficient to provide a seal between the blister 14 and the moisture barrier 20, is releasable upon manual removal of the blister therefrom. Once the blister is removed, the container 16 may be used in conventional fashion.

ITEMS:

Item 1, A package assembly comprising:

a planar member having a first surface;

a vapor barrier disposed on a selected portion of said first surface and defining a footprint thereon;

a container positioned adjacent said vapor barrier, said container being positioned within said footprint so as to define a perimetrical vapor barrier edge portion therearound; and

a blister cover having a blister cavity for receipt of said container and a planar perimetrical rim thereabout;

said blister cover being supported on said first surface of said planar member with said perimetrical rim overlying said vapor barrier edge portion.

Item 2, A package assembly of item 1 wherein said vapor barrier is a moisture barrier.

Item 3, A package assembly of items 1-2 wherein said blister cavity rim is sealed to said first surface of said planar member.

Item 4. A package assembly of item 2 wherein said moisture barrier is a substrate selected from the group consisting of foil, metalized film and combinations thereof.

Item 5. An assembly of items 1-4 wherein said blister cover N removable from said planar member.

Item 6. An assembly of items 1-5 wherein said planar member forms a hang card.

Item 7 An assembly of item 4 wherein said substrate is hot stamped onto said first surface.

Item 8. An assembly of items 1-5 wherein said planar member s formed of blister board.

Item 9. A package assembly of items 1-8 wherein said container has a major planar extent in engagement with said planar member and wherein said major planar extent lies within said footprint of said vapor barrier.

Item 10. A package assembly of item 3 wherein said perimetrical rim of said blister cover configuration overlies said vapor barrier edge portion.

Item 11. A package assembly of item 3 wherein said perimetrical rim of said blister cover partially overlies said vapor barrier edge portion.

Item 12. A method of forming a package assembly comprising the steps of:

forming a planar member;

depositing a vapor barrier on a selected portion of said planar member to define a footprint having a perimetrical edge portion;

providing a blister cover having a blister cavity and a planar rim thereabout;

positioning a container in said blister cavity; and

attaching said planar member to said blister cover such that said rim of said blister cover overlies said edge portion of said vapor barrier.

Item 13. A method of item 12 wherein said vapor barrier is a moisture barrier.

Item 14. A method of items 12-13 wherein said forming step includes forming said planar member from blister board stock.

Item 15. A method of items 12-14 wherein said forming step further includes cutting a fiat blank from said blister board stock.

Item 16. A method of items 12-15 wherein said depositing step includes depositing a substrate to form said moisture barrier.

Item 17. A method of items 12-16 wherein said substrate is selected from the group consisting of foil, metalized film and combinations thereof.

Item 18. A method of item 17 wherein said depositing step further includes hot stamping said substrate onto said planar member.

Item 19. A package for supporting product comprising:

a planar member having a first surface;

a vapor barrier disposed on a selected portion of said first surface and defining a product accommodating footprint thereon; and

a blister cover having a blister cavity receipt of said product and a planar perimetrical rim therearound;

said blister cover being supported on said first surface of said planar member with said perimeterical rim overlying perimetrical edge portion of said vapor barrier.

Item 20. A package of item 19 wherein said vapor barrier is a moisture barrier.

Item 21. A package of items 19-20 wherein said blister cavity rim is sealed to said first surface of said planar member.

Item 22. A package of item 20 wherein said moisture barrier is a substrate selected from the group consisting of foil, metalized film and combinations thereof.

Item 23, A package of items 19-22 wherein said planar member forms a hang card.

Item 24. A package of items 19-22 wherein said product includes at least one item and wherein said at least one item is positionable within said footprint of said planar member.

Item 25. A package of item 24 wherein said at least one item is selected from the group consisting of loose consumable pieces, packaged consumable pieces and combinations thereof.

Various changes to the foregoing described and shown structures would now be evident to those skilled in the art. Accordingly, the particularly disclosed scope of the invention is set forth in the following claims.

What is claimed is:

1. A package assembly comprising:
a planar member having a first surface;
a vapor barrier disposed on a selected portion of said first surface and defining a footprint thereon;
a container positioned adjacent said vapor barrier, said container being positioned within said footprint so as to define a perimetrical vapor barrier edge portion therearound; and
a blister cover having a blister cavity for receipt of said container and a planar perimetrical rim thereabout;
said blister cover being supported on said first surface of said planar member with said perimetrical rim overlying said vapor barrier edge portion.

2. A package assembly of claim 1 wherein said vapor barrier is a moisture barrier.

3. A package assembly of claim 1 wherein said blister cavity rim is sealed to said first surface of said planar member.

4. A package assembly of claim 2 wherein said moisture barrier is a substrate selected from the group consisting of foil, metalized film and combinations thereof.

5. An assembly of claim 4 wherein said blister cover is removable from said planar member.

6. An assembly of claim 1 wherein said planar member forms a hang card.

7. An assembly of claim 4 wherein said substrate is hot stamped onto said first surface.

8. An assembly of claim 5 wherein said planar member is formed of blister board.

9. A package assembly of claim 1 wherein said container has a major planar extent in engagement with said planar member and wherein said major planar extent lies within said footprint of said vapor barrier.

10. A package assembly of claim 3 wherein said perimetrical rim of said blister cover configuration overlies said vapor barrier edge portion.

11. A package assembly of claim 3 wherein said perimetrical rim of said blister cover partially overlies said vapor barrier edge portion.

12. A method of forming a package assembly comprising the steps of:
forming a planar member;
depositing a vapor barrier on a selected portion of said planar member to define a footprint having a perimetrical edge portion;
providing a blister cover having a blister cavity and a planar rim thereabout;
positioning a container in said blister cavity; and
attaching said planar member to said blister cover such that said rim of said blister cover overlies said edge portion of said vapor barrier.

13. A method of claim 12 wherein said vapor barrier is a moisture barrier.

14. A method of claim 12 wherein said forming step includes forming said planar member from blister board stock.

15. A method of claim 12 wherein said forming step further includes cutting a flat blank from said blister board stock.

16. A method of claim 12 wherein said depositing step includes depositing a substrate to form said moisture barrier.

17. A method of claim 16 wherein said substrate is selected from the group consisting of foil, metalized film and combinations thereof.

18. A method of claim 17 wherein said depositing step further includes hot stamping said substrate onto said planar member.

19. A package for supporting product comprising:
a planar member having a first surface;
a vapor barrier disposed on a selected portion of said first surface and defining a product accommodating footprint thereon; and
a blister cover having a blister cavity receipt of said product and a planar perimetrical rim therearound;
said blister cover being supported on said first surface of said planar member with said perimeterical rim overlying perimetrical edge portion of said vapor barrier.

20. A package of claim 19 wherein said vapor barrier is a moisture barrier.

21. A package of claim 19 wherein said blister cavity rim is sealed to said first surface of said planar member.

22. A package of claim 20 wherein said moisture barrier is a substrate selected from the group consisting of foil, metalized film and combinations thereof.

23. A package of claim 19 wherein said planar member forms a hang card.

24. A package of claim 19 wherein said product includes at least one item and wherein said at least one item is positionable within said footprint of said planar member.

25. A package of claim 24 wherein said at least one item is selected from the group consisting of loose consumable pieces, packaged consumable pieces and combinations thereof.
